(19) United States
(12) Patent Application Publication
(10) Pub. No.: US 2017/0249971 A1
(43) Pub. Date: Aug. 31, 2017

(54) METHOD FOR GENERATING IMAGE IN WHICH SOUND SOURCE IS INSERTED AND APPARATUS THEREFOR

(71) Applicant: SEERSLAB, INC., Seoul (KR)

(72) Inventors: Jin Wook CHONG, Seoul (KR); Jae Cheol KIM, Seoul (KR)

(73) Assignee: SEERSLAB, INC., Seoul (KR)

(21) Appl. No.: 15/338,361

(22) Filed: Oct. 29, 2016

(30) Foreign Application Priority Data
Feb. 29, 2016 (KR) 10-2016-0024044

(51) Int. Cl. G11B 27/036; H04N 5/232; G11B 27/34; H04N 21/81; H04N 21/472; H04N 21/485; H04N 21/431; H04N 5/45; G11B 27/00

(52) U.S. Cl. CPC G11B 27/036; H04N 5/45; H04N 5/23293; H04N 5/23216; G11B 27/34; G11B 27/005; H04N 21/47205; H04N 21/4852; H04N 21/4316; H04N 21/812

(57) ABSTRACT

Disclosed herein are a method and apparatus for generating an image in which a sound source is inserted. The method for generating an image in which a sound source is inserted includes displaying a subject, an image of which is captured using a camera, selecting a sound source, inserting the selected sound source as a background sound source of an image being captured when the image including the subject is captured, and generating an image in which the selected sound source is inserted as the background sound source.

### CROSS REFERENCE TO RELATED APPLICATION

This application claims the benefit of Korean Patent Application No. 10-2016-0024044, filed Feb. 29, 2016, which is hereby incorporated by reference in its entirety into this application.

### BACKGROUND OF THE INVENTION

1. Technical Field

The present invention relates generally to technology for generating an image in which a sound source is inserted and, more particularly, to a method and apparatus for generating an image through which a sound source, such as a song or music video provided from an external sound source provision service, may automatically be inserted in an image as a background sound source thereof when the image is captured.

2. Description of the Related Art

These days, because most mobile devices include digital cameras, users may capture images using camera modules installed in the mobile devices. Video data captured using a mobile device may be stored in the memory of the mobile device after an image processing process based on a technical standard such as MPEG 4 is performed on the video data. The video data stored in the mobile device may be played therein, or may be transmitted to another device through wireless communication.

Meanwhile, in order to play or transmit a video file, a mobile device is required to acquire image data using a digital camera installed therein. To this end, a user manipulates the digital camera. When the user starts recording a video, light sensed by an image sensor installed in the camera module of the mobile device is transformed to electrical signals, and the correction of errors and distortion, the synchronization between an image and sound, and image processing, such as multiplexing, compression or the like, are performed through known processes predefined in the hardware and software of the camera module, and the data are then stored in the memory as a video file.

### SUMMARY OF THE INVENTION

Embodiments of the present invention provide an image generation method and apparatus configured such that, when an image is captured, a sound source, such as a song or music video provided from an external sound source provision service, is automatically inserted as a background sound source of the image that is being captured, whereby an image into which a sound source is inserted may be generated.

A method for an image in which a sound source is inserted according to an embodiment of the present invention includes displaying a subject, an image of which is captured using a camera; selecting a sound source; when an image including the subject is captured, inserting the selected sound source in the image as a background sound source of the image being captured; and generating an image in which the selected sound source is inserted as the background sound source.

Selecting the sound source may be configured to display a sound player on a screen and to select the sound source in the sound player based on user input, and inserting the selected sound source may be configured such that, when an image capture function is selected based on the user input, the sound player that is playing the selected sound source is moved to a Picture-In-Picture (PIP) window and then the image is captured.

The method may further include displaying a preset advertisement on a part of a screen when a sound player is displayed on the screen.

The method may further include setting a playback start point of the selected sound source based on user input, wherein inserting the selected sound source may be configured such that a part of the selected sound source, starting from the set playback start point, is inserted as the background sound source of the image being captured.

The method may further include setting a playback section of the selected sound source based on user input, wherein inserting the selected sound source may be configured such that the set playback section of the selected sound source is inserted as the background sound source of the image being captured.

Inserting the selected sound source may be configured such that, when capture of the image is interrupted, playback of the selected sound source is paused, and when the capture of the image is resumed, the selected sound source is played again, whereby the selected sound source may be inserted as the background sound source of the image being captured.

Selecting the sound source may be configured to select multiple sound sources based on user input, and inserting the selected sound source may be configured to sequentially insert the multiple sound sources at regular intervals as the background sound source of the image being captured.

Inserting the selected sound source may be configured such that, when capture of the image is interrupted, playback of the selected sound source is paused, and when the capture of the image is resumed after another sound source is newly selected by user input, the newly selected sound source is played, whereby the first selected sound source and the newly selected sound source are sequentially inserted as the background sound source of the image being captured.

The image in which the selected sound source is inserted as the background sound source may be shared through at least one preset application.

In selecting the sound source, sound sources collected by crawling one or more preset external sound source provision services may be provided, or sound source files may be provided by being downloaded based on a sound source list previously provided by a service, and the sound source may be selected from among the provided sound sources based on the user input.

The method may further include displaying the image in which the selected sound source is inserted as the background sound source; and storing the image in which the selected sound source is inserted as the background sound source in a state in which the PIP window is included in the image or in a state in which the PIP window is excluded from the image depending on a selection by a user.

A method for generating an image in which a sound source is inserted according to another embodiment of the present invention includes displaying any one image selected from among multiple images that have been stored in advance; selecting a sound source; inserting the selected sound source as a background sound source of the selected image; and generating an image in which the selected sound source is inserted as the background sound source for the selected image.

An apparatus for generating an image in which a sound source is inserted according to an embodiment of the present invention includes a display unit for displaying a subject, an image of which is captured using a camera; a selection unit for selecting a sound source; a capture unit for capturing an image including the subject; an insertion unit for inserting the selected sound source as a background sound source of a captured image when the image including the subject is captured; and a generation unit for generating an image in which the selected sound source is inserted as the background sound source.

The selection unit may select the sound source based on user input in a sound player displayed on a screen, and when an image capture function is selected based on the user input, the capture unit may capture the image after moving the sound player that is playing the selected sound source to a Picture-in-Picture (PIP) window.

The display unit may display a preset advertisement on a part of a screen when a sound player is displayed on the screen.

The selection unit may set a playback start point of the selected sound source based on user input, and the insertion unit may insert a part of the selected sound source, starting from the set playback start point, as the background sound source of the captured image.

The selection unit may set a playback section of the selected sound source based on user input, and the insertion unit may insert the set playback section of the selected sound source as the background sound source of the captured image.

The insertion unit may insert the selected sound source as the background sound source of the captured image in such a way that when capture of the image is interrupted, playback of the selected sound source is paused, and when the capture of the image is resumed, the selected sound source is played again.

The selection unit may select multiple sound sources based on user input, and the insertion unit may sequentially insert the multiple sound sources at regular intervals as the background sound source of the captured image.

When capture of the image is interrupted, playback of the selected sound source is paused, and when the capture of the image is resumed after another sound source is newly selected by user input, the newly selected sound source is played, whereby the insertion unit may sequentially insert the first selected sound source and the newly selected sound source as the background sound source of the captured image.

The image in which the selected sound source is inserted as the background sound source may be shared through at least one preset application.

The selection unit may provide sound sources collected by crawling one or more preset external sound source provision services or sound source files downloaded based on a sound source list previously provided by a service, and may select the sound source from among the provided sound sources based on the user input.

The apparatus may further include a storage unit for storing the image in which the selected sound source is inserted as the background sound source in a state in which the PIP window is included in the image or in a state in which the PIP window is excluded from the image depending on a selection by a user, when the image in which the selected sound source is inserted as the background sound source is displayed.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an example for describing the present invention;

FIG. 2 shows a flowchart of a method for generating an image in which a sound source is inserted according to an embodiment of the present invention;

FIGS. 3A and 3B show an example for describing the process of executing a music mode;

FIGS. 4A and 4B show an example of a sound player displayed on a screen when a music mode is executed;

FIGS. 5A and 5B show an example of a screen using a PIP feature and a screen on which an image to which an effect is applied is displayed;

FIGS. 6A and 6B show a screen view displayed while an image is being captured and a screen view displayed when the capture of an image is interrupted;

FIGS. 7A and 7B show an example for describing the process of storing a captured image;

FIG. 8 shows the configuration of an apparatus for generating an image in which a sound source is inserted according to an embodiment of the present invention; and

FIGS. 9A, 9B and 9C show an example of a player for playing local sound sources and BGM and a list of the sound sources.

### DESCRIPTION OF THE PREFERRED EMBODIMENTS

Hereinafter, embodiments according to the present invention will be described in detail with reference to the accompanying drawings. However, the present invention is not limited to the embodiments. Also, the same reference numerals are used to designate the same or similar elements throughout the drawings.

Embodiments of the present invention are intended to generate an image in which a sound source is inserted in such a way that, when an image is captured, a sound source, such as a song or music video provided from an external sound source provision service, is automatically inserted as a background sound source of the image that is being captured.

Here, the embodiments of the present invention may provide local sound sources stored in a user device when an image is captured, or may download background music (BGM) from the server of a service provider, which provides the technology of the present invention, and provide the downloaded music. Also, in the embodiments of the present invention, sound sources may include not only songs and music videos but also dialogue, sound effects, background music and the like.

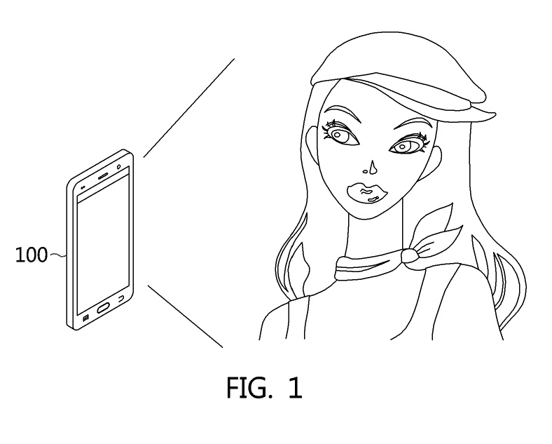

FIG. 1 shows an example for describing the present invention.

As illustrated in FIG. 1, the present invention may be applied to a device 100 having a camera, for example, a smart phone or the like, and may be installed in the smart phone or the like in the form of an application. Accordingly, when the image of a subject is captured using a camera, for example, when a video is recorded, a local sound source file stored on the user device, such as a smart phone or the like, or a sound source provided from an external sound source provision service, for example, a song or a music video, is provided as the background sound source of the image (or video) that is being captured (or recorded), whereby an image (or video) in which the corresponding sound source is inserted as the background sound source thereof may be captured (or recorded).

Here, the present invention may provide an existing image-capture mode (hereinafter, referred to as “general mode”) and a mode for capturing an image in which a sound source is inserted (hereinafter, referred to as “music mode”), and may also provide all modes for capturing an image using a camera.

Furthermore, the present invention provides specific effects, for example, motion effects or the like, both in the general mode and in the music mode, and enables an image to which the effect selected by a user is applied to be captured. For example, if a motion effect is applied to an image that is being captured in the music mode, a sound source is inserted into the image to which the motion effect is applied, whereby an image to which the motion effect is applied and in which the sound source is inserted as a background sound source may be generated.

In the present invention, subjects to be captured may include various objects, for example, people, buildings, cars and the like, and the effect to be applied when an image is captured may be applied to different areas in the image depending on information about the effect selected by a user and information about objects included in the subjects to be captured.

Hereinafter, the present invention will be described as being performed in a smart phone having a camera for the convenience of description. Of course, the present invention is not limited to being applied to a smart phone, and it will be clearly understood by those skilled in the art that the present invention may be applied to all the devices on which a camera is installed.

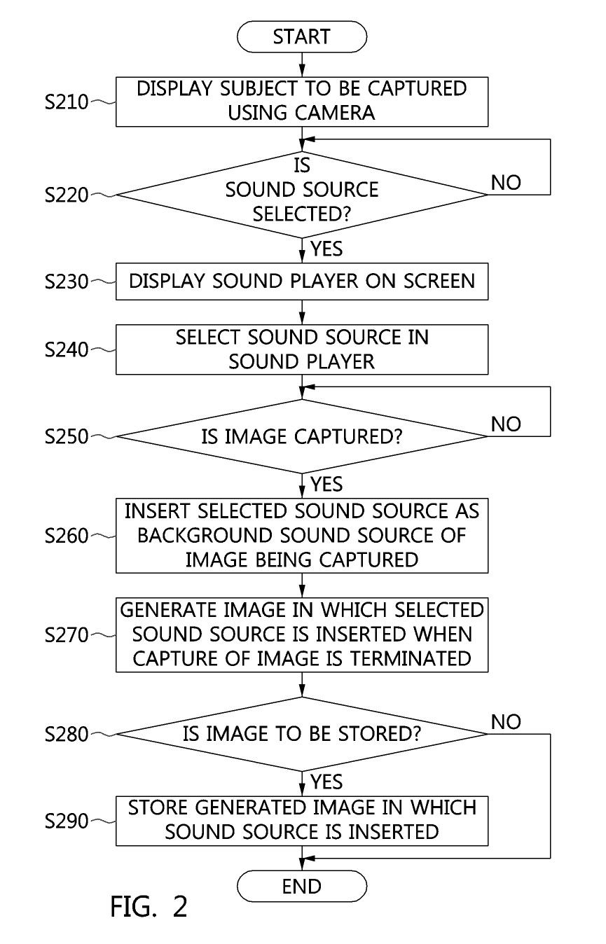

FIG. 2 shows a flowchart of a method for generating an image in which a sound source is inserted according to an embodiment of the present invention.

Referring to FIG. 2, in a method for generating an image in which a sound source is inserted according to an embodiment of the present invention, an application for the present invention is executed, and subjects to be captured using a camera of the device in which the application has been installed, for example, subjects including objects, such as cars, scenery, people or the like, are displayed on a screen at step S210.

Here, various filtering functions selected by a user may be applied to the subjects displayed at step S210, or various functions of the camera for capturing the subjects may be applied to the subjects.

When the subjects are displayed on the screen at step S210, a music mode function, provided in the application in order to select a sound source, is executed based on user input, whereby a sound player preset for selecting a sound source is displayed on the screen at steps S220 and S230.

At step S230, sound sources, such as songs and music videos collected by crawling the content of a preset external sound source provision service, for example, YouTube, a music site or the like, may be provided through the displayed sound player. Also, in the method according to the present invention, not only may sound sources be provided from an external sound source provision service, sound sources selected by a user from a music site that is accessible using the ID and password of the user may be provided through the sound player. Also, a service may provide a sound source list in advance, and sound sources in the list may be provided as downloadable sound source files, and sound sources stored in the user device may also be provided through the sound player.

In other words, at step S230, not only sound sources provided from an external sound source provision service but also local sound sources stored in the user device may be provided. Also, at step S230, background music (BGM) provided from the server of a service provider, which provides the technology of the present invention, may be downloaded therefrom and then provided. Of course, in the embodiment of the present invention, sound sources may include dialogue, sound effects, background music and the like as well as songs and music videos.

Further, at step S230, not only a sound player but also at least one advertisement selected from among preset advertisements may be exposed or displayed on a part of the screen, in which case the displayed advertisement may be a banner advertisement or a video advertisement.

Here, the banner advertisement may be configured with either text or images or with both text and images. The landing page of the corresponding advertisement may be limited to the page of app-stores and HTML pages. Here, the banner advertisement may vary depending on information about the selected sound source, for example, song information, music video information or the like.

Also, the video advertisement may have a non-skippable part, which viewers are forced to watch, and may include a “Skip” button for playing content subsequent to the advertisement. Also, in the present invention, if viewers watch the corresponding video advertisement for a time longer than a certain time period, a reward therefor may be provided.

When the sound player for providing the sound sources is displayed on the screen, for example, on a part of the screen, at step S230, a sound source to be inserted into the image to be captured as the background sound source thereof is selected in the sound player based on user input at step S240.

Here, a single sound source or multiple sound sources may be selected as the sound source to be inserted as a background sound source, and at least one of a playback start point, a playback end point and a playback section may be set in the selected sound source. At least one sound source selected at step S240 and setting information related to the playback may be used at step S260.

After at least one sound source to be inserted as a background sound source is selected at step S240, if the capture of an image, specifically, the capture of an image in the music mode, is performed through user input, the sound source selected at step S240 is inserted as the background sound source of the image that is being captured by a user at steps S250 and S260.

Here, at step S260, when the capture of an image is started, the sound player that plays the selected sound source is moved to a Picture-In-Picture (PIP) window, and the playing sound source may be inserted as the background sound source of the image that is being captured.

In this case, if multiple sound sources are selected at step S240, the multiple sound sources may be sequentially inserted at regular intervals as the background sound source of the image being captured at step S260. Of course, if a playback section is set in the selected sound source, only the set playback section may be inserted as the background sound source of the image being captured.

Also, at step S260, when the capture of the image is interrupted in the music mode, the playback of the selected sound source is paused, and when the capture of the image is resumed, the selected sound source is played again, whereby the selected sound source may be inserted as the background sound source of the image being captured.

Here, when the capture of the image is interrupted, the sound player in the PIP window may be activated by selecting it, and another sound source to be inserted may be selected in the sound player. Then, if the capture of the image is resumed after the other sound source is selected, the sound player is again moved to the PIP window, and the newly selected sound is inserted as a background sound source of the image from the time point at which the capture of the image is resumed.

When the selected sound source is inserted into the image being captured as the background sound source thereof at steps S250 and 260 and when the capture of the image in the music mode is terminated based on user input, an image in which the selected sound source, which was played until the capture of the image was terminated, is inserted as the background sound source thereof is generated, and if a user intends to store the image generated in the music mode through the user input, the generated image in which the sound source is inserted is stored in the corresponding device at steps S270 to S290.

Here, at step S270, a preset watermark may be arranged in a certain area of the captured image, and then an image in which a sound source is inserted may be generated. Also, at step S290, if a sound player in the PIP window plays a music video, for example, if the sound source is a music video, the music video playing in the PIP window may be stored by being included in the captured image based on the user input, or the image in the PIP window may be excluded when the captured image is stored.

Further, the image in which a sound source is inserted, which is generated at step S270, may be displayed on the screen through a preview function or the like, and may be shared using at least one preset application, for example, a messenger service such as LINE, KakaoTalk or the like, a social network service, or the like.

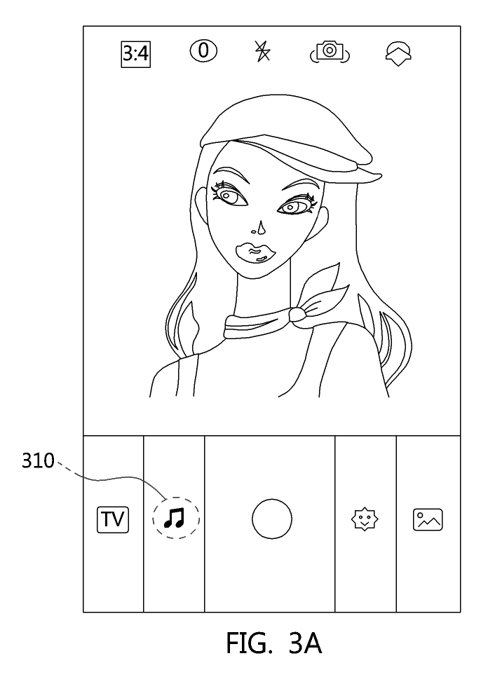

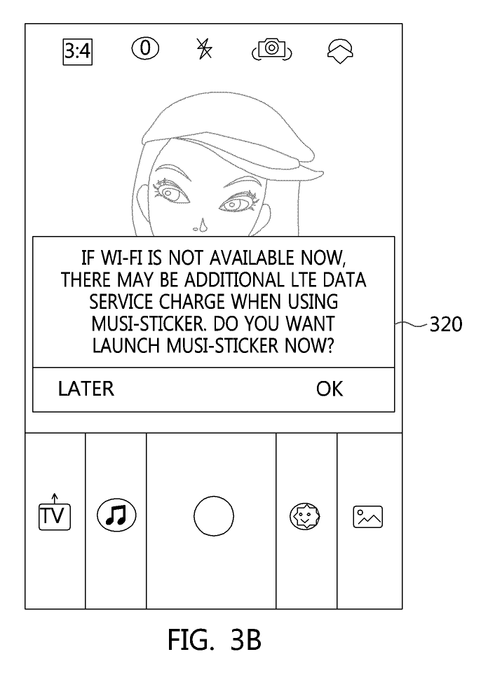

The method according to an embodiment of the present invention will be described below with reference to FIGS. 3 to 7.

When an application for implementing the present invention is executed by a user, a subject to be captured using a camera of the device in which the application has been installed or using a camera connected to such a device is displayed on a part of a screen, as shown in the example in FIG. 3A.

Here, a means for setting or changing various functions related to the capture of an image may also be displayed on the part of the screen on which the subject to be captured is displayed, and a music mode button 310 for switching to a music mode and a user interface for checking a stored image, selecting an effect to be applied, capturing an image, and the like may also be displayed on a part of the screen.

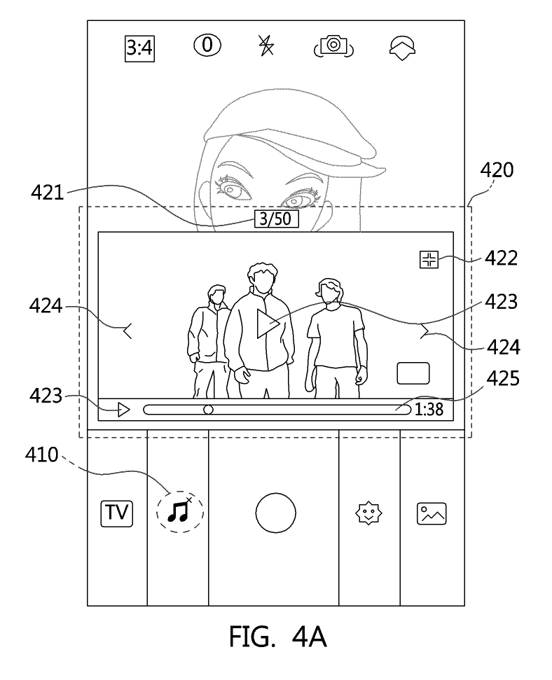

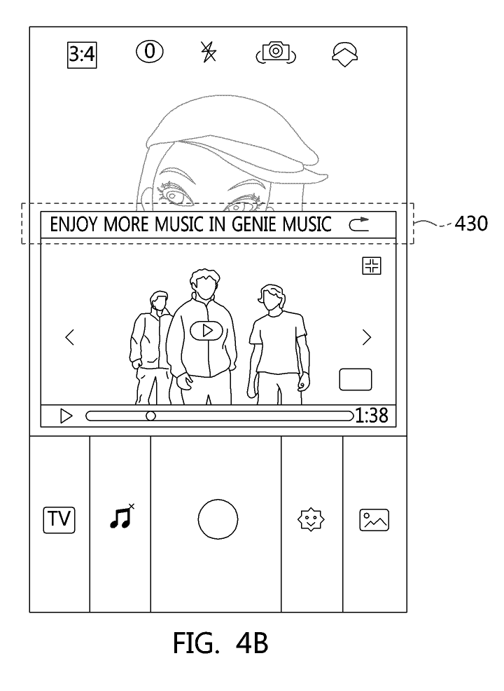

When the music mode button 310 illustrated in FIG. 3A is selected by a user in order to execute the music mode, a specific message 320 related to the music mode, for example, a popup message for receiving approval for an additional charge for the use of a data service, may be displayed on the screen, as shown in FIG. 3B, before the execution of the music mode. Here, if the user selects a “Later” button on the popup message, the popup message disappears, and the general mode is maintained on the screen, but if the user selects an “OK” button on the popup message, the mode is switched to the music mode, as shown in FIG. 4A, and a sound player for executing the music mode and a user interface related thereto are provided.

When the music mode is executed by the user, a sound player 420 for selecting a sound source is displayed on a part of the screen, and a music mode release button 410 for releasing the music mode is provided in the user interface, as shown in FIG. 4A.

Here, if the music mode release button 410 is selected by the user, the sound player 420 is closed, and the music mode release button may be switched to a music mode button for executing the music mode.

The sound player 420 illustrated in FIG. 4A is an example of a player for playing a music video, and the sound player 420 may include a sound source location bar 421, a progress bar 425, a play/pause button 423, a sound source change button 424, a minimization button 422 and the like.

Here, the sound source location bar 421 shows the order of the sound source playing in the sound player, among the sound sources provided therein, for example, the order of the current streaming sound source in the list of the 30 most popular music videos collected by crawling an external sound source provision service, and if there is no additional operation for two seconds after swiping, the sound source location bar 421 may disappear. The progress bar 425 may be used to set at least one of a playback start point, a playback end point and a playback section in the sound source. The sound source change button 424 changes the sound source to another sound source selected by a user. Also, the minimization button 422 enables the sound player to be moved to a PIP window when selected by a user. Here, if the minimization button is selected in the state in which the sound source is a music video, the image of the music video is stopped, and then the sound player may switch to a PIP window.

Also, in the method according to the present invention, when the music mode is executed, not only a sound player but also a specific advertisement 430 may be displayed on a part of the screen, for example, in the upper part of the sound player, as shown in FIG. 4B.

Here, the displayed advertisement may be a banner advertisement or an advertisement clip, and when the displayed advertisement is selected by a user, a page from which an app related to the corresponding advertisement may be downloaded or a specific website may open. Of course, if the sound player is moved to a PIP window, no advertisement is shown.

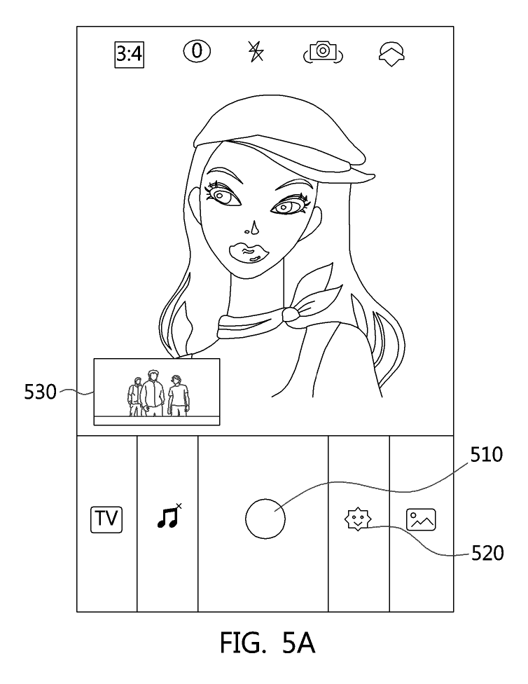

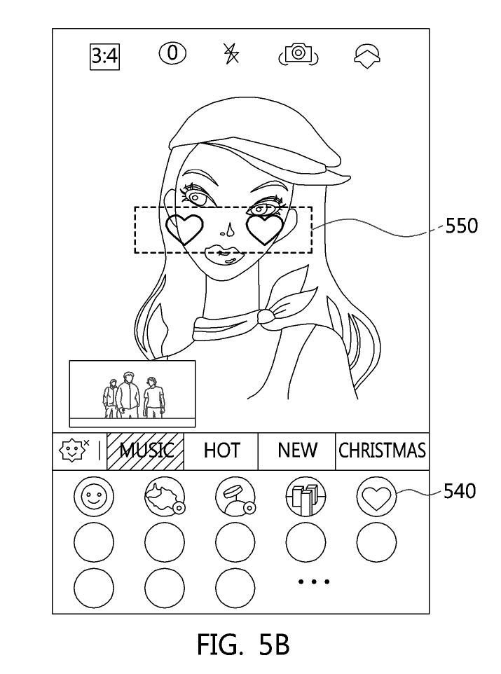

As illustrated in FIGS. 4A and 4B, when a sound player is displayed, a user may select at least one sound source from among the sound sources provided in the sound player, and if the sound player is moved to a PIP window, the sound player 530 in the PIP window may be displayed on a part of the screen, as shown in FIG. 5A.

The user may capture an image by selecting a capture button 510 for capturing an image in the music mode in the user interface provided on the screen of FIG. 5A. Also, in order to apply a specific effect to a subject when capturing the image thereof, the user may select an effect selection button 520, whereby various effects applicable to the subject, for example, a motion effect, stickers and the like, are displayed on a part of the screen, as shown in FIG. 5B.

Here, FIG. 5B shows an example in which a user selects a heart image sticker 540. When the heart image sticker 540 is selected, the heart image sticker may be applied to a target portion of the subject, for example, the cheeks 550 of a person.

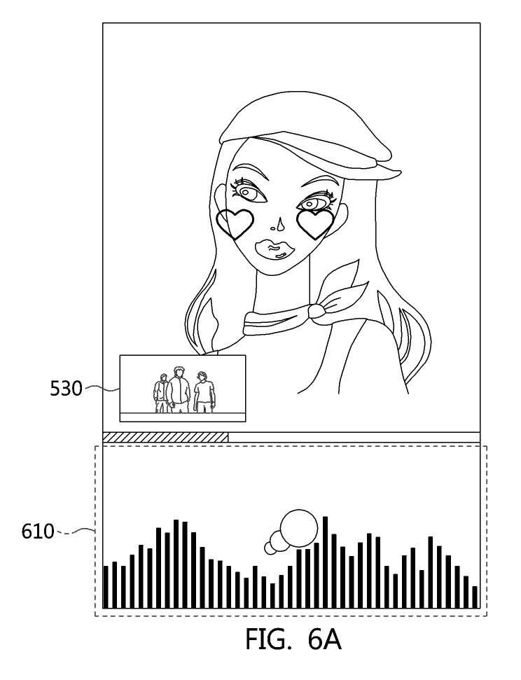

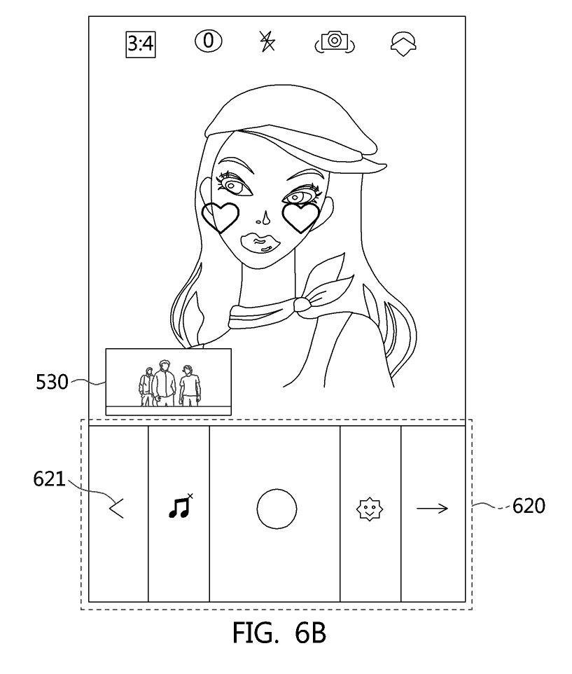

In the state in which the heart image sticker is applied, when a user selects a function 510 to capture an image, for example, when the user touches a capture button for a certain time, a video recording function for the subject is executed, and an image 610, announcing that the recording of a video is progressing in the music mode, is displayed on a part of the screen, as in the example shown in FIG. 6A.

Here, the music mode may provide only a video recording function. Accordingly, if the capture of a still image, rather than the recording of a video, is attempted in the music mode, a message saying “Only video recording is available in music mode. Please press and hold the button.” may be displayed.

As illustrated in FIG. 6A, the sound player plays a sound source in the PIP window 530 while recording a video in the music mode. Here, if the selected sound source is a music video, the music video is played in the PIP window.

Meanwhile, if the recording of the video is interrupted, that is, if the capture button is released by a user, a user interface 620 including a section deletion button 621, through which each section of the recorded video may be deleted, is provided, as shown in FIG. 6B, and the playback in the sound player in the PIP window 530 is stopped.

Here, the user selects the sound player in the PIP window, and thereby activates the sound player so as to be displayed on the screen. Accordingly, the user may select another sound source through the sound player. Of course, if the recording of the video is resumed after the other sound source is selected, the sound player on which the other sound source is selected is moved to a PIP window, and the newly selected sound source is played, whereby the newly selected sound source may be additionally inserted as the background sound source of the video being recorded.

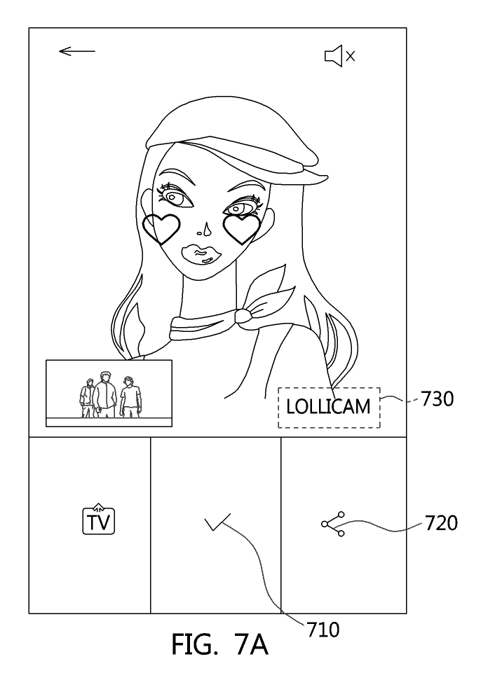

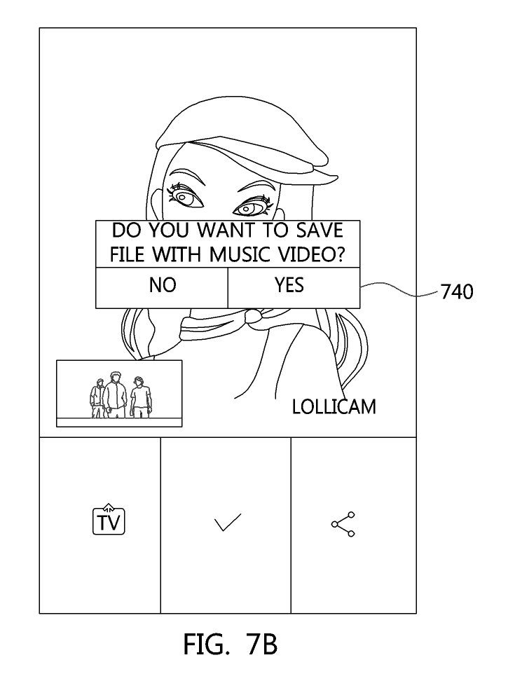

When the recording of a video in the music mode is completed through the processes of FIGS. 3 to 6, a video in which a sound source selected by a user, for example, at least one of a song and a music video, is inserted is generated as illustrated in FIG. 7A, and the generated video is displayed on the screen through a preview function.

Here, the generated video is displayed on the screen in such a way that the recorded video containing the subject is played along with the sound source in the PIP window, for example, a music video in the PIP window, and a preset watermark 730 is arranged in a certain area of the image of the generated video. Also, a save button 710 for storing the generated video and a share button 720 for sharing the corresponding video using at least one preset application are provided through a user interface.

If the save button 710 is selected in the preview screen of FIG. 7A in order to store the video recorded in the music mode, a popup message 740 for prompting the user to determine whether to include the video in the PIP window in the recorded video when the recorded video is stored is displayed, as shown in FIG. 7B.

Here, if a user selects a “Yes” button in the popup message window, a video including the video in the PIP window is stored, but if the user selects a “No” button, a video excluding the video in the PIP window is stored. Naturally, when a share button or a TV button is selected in the view illustrated in FIG. 7A, the popup message for prompting a user to determine whether to include the video in the PIP window may be displayed, as shown in FIG. 7B.

As described above, in the method for generating an image in which a sound source is inserted according to an embodiment of the present invention, because an image is captured after at least one sound source is selected from among multiple sound sources provided from an external sound source provision service, for example, songs, music videos and the like, through video recording using a music mode, the selected sound source may be inserted as the background sound source of the image being captured, whereby an image in which the sound source is automatically inserted, for example, a video, may be generated.

In the method according to an embodiment of the present invention, if a user records a video while playing the desired background sound source on the screen for the recording, the currently playing sound source may be automatically inserted as the background sound source of the video being recorded by the user.

Here, the sound player executable on the screen while recording a video in the music mode may play sound sources on the Internet (for example, a video, music, sound provided through streaming, and the like) and sound sources in the mobile phone (for example, a video file, a music file, a sound file and the like).

Also, in the method for generating an image in which a sound source is inserted according to the present invention, not only may a sound source be selected and applied when capturing the image of a subject in the music mode, a sound source may also be inserted in a previously stored video, whereby a video in which the sound source is inserted may be generated. That is, in a method according to another embodiment of the present invention, any one image selected from among multiple previously stored images is displayed on the screen, the sound source to be inserted is selected by selecting a music mode, and the selected sound source is inserted as the background sound source of the selected image, whereby the sound source may be inserted as the background sound source in the image that has been captured and stored in the general mode. Of course, all applicable methods, such as a method for selecting multiple sound sources and sequentially inserting them, a method in which the playback of a video is interrupted when a sound source is inserted and another sound is selected and inserted in the video, and the like, may be applied.

Also, in the method for generating an image in which a sound source is inserted according to the present invention, sound sources (including music and music videos) stored in a user device such as a smart phone may be loaded on a screen for capturing an image, for example, a viewfinder screen on which a subject to be captured is displayed, and if at least one sound source is selected from among the sound sources stored in the user device, the selected sound source is played on the screen for capturing an image. Surely, a playback section to be played and to be inserted in the image may be set or selected in the selected sound source, and if the capture of an image is started based on user input after the playback section is set, the playing sound source is automatically inserted as the background sound source of the image being captured.

Here, the capture of the image is interrupted, and then another sound source stored in the user device may be selected. Also, the playback section of the selected sound source may be set again, and then the capture may be resumed. Of course, when the other sound source is selected, the playback section may also be set based on the user input.

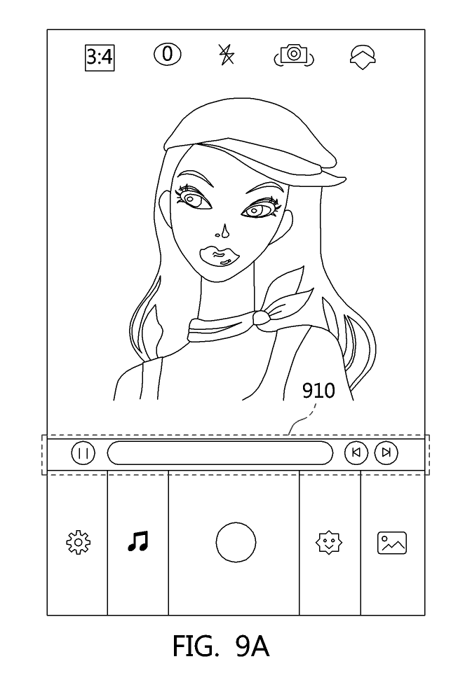

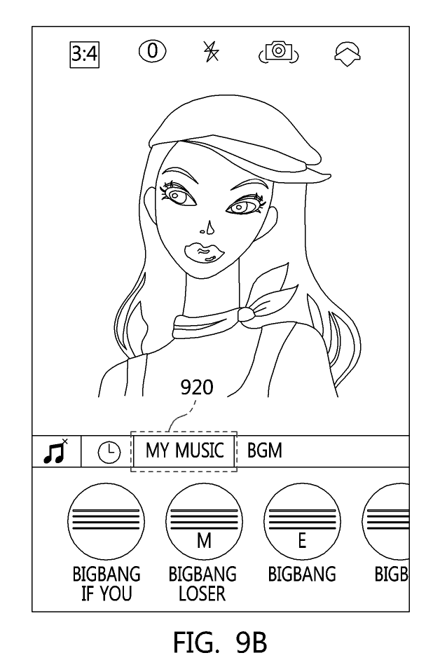

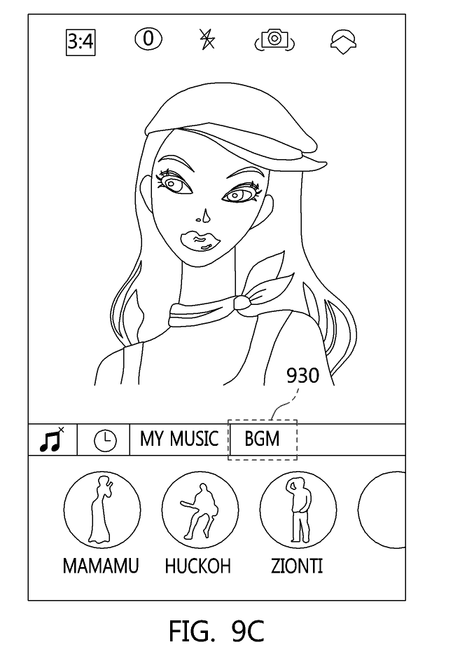

For example, a local sound source and a BGM sound source stored in a user device may be selected using a player 910 for local sound sources and BGM sound sources, as illustrated in FIG. 9A. Here, if a user selects a “My music” item 920, as shown in FIG. 9B, a local sound source list for the local sound sources is displayed on the screen, whereby at least one sound source may be selected from the sound sources in the local sound source list. Also, if a “BGM” item 930 is selected, as shown in FIG. 9C, a BGM list for BGM sound sources is displayed on the screen, whereby at least one sound source may be selected from among the sound sources in the BGM list.

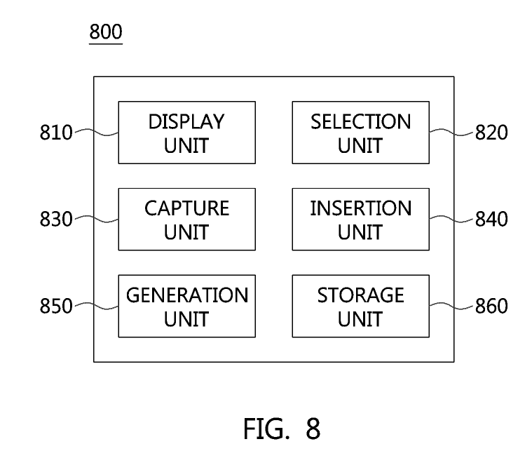

FIG. 8 shows the configuration of an apparatus for generating an image in which a sound source is inserted according to an embodiment of the present invention, and shows the apparatus for performing the method for generating an image in which a sound source is inserted, described with reference to FIGS. 2 to 7.

Here, the apparatus 800 for generating an image in which a sound source is inserted may be included in any device in which a camera is installed.

Referring to FIG. 8, the apparatus 800 according to an embodiment of the present invention includes a display unit 810, a selection unit 820, a capture unit 830, an insertion unit 840, a generation unit 850, and a storage unit 860.

The display unit 810 is a unit for displaying all the data related to the present invention, such as the subject to be captured using the camera, the sound source player executed by selecting a music mode, the generated image in which the sound source is inserted, the user interface and the like.

Here, the display unit 810 is a means for displaying data, and may be for example a touch screen of a smart phone.

Further, the display unit 810 may expose or display a preset advertisement on a part of the screen when a sound player is displayed on the screen.

The selection unit 820 is a unit for selecting at least one sound source to be inserted as a background sound source of the image being captured, and enables at least one sound source to be selected based on user input in the sound player displayed on the screen in the music mode.

Here, the selection unit 820 may set at least one of a playback start point, a playback end point and a playback section. Also, when multiple sound sources are inserted as the background sound source of the image being captured, the selection unit may select the multiple sound sources based on user input, and may set a playback section in each of the selected sound sources.

The selection unit 820 provides sounds sources collected by crawling one or more preset external sound source provision services, whereby the collected sound sources may be provided through the displayed sound player. Accordingly, at least one sound source may be selected from among the provided sound sources based on user input.

The capture unit 830 captures the image of a subject displayed in the display unit in a capture mode provided in the present invention, for example, in a general mode or a music mode.

Here, if a motion effect is selected based on user input, the capture unit 830 may capture the image of a subject to which the motion effect is to be applied.

Also, if an image capture function is selected based on user input in the music mode, the capture unit 830 may capture an image after moving the sound player that is playing the selected sound source to a PIP window.

Here, if the sound player, having been moved to the PIP window, plays a video such as a music video, the video in the PIP window is played while capturing an image, but the video is paused when the capture of the image is interrupted.

The insertion unit 840 inserts the sound source selected by the user as the background sound source of the image being captured.

Here, when the capture of an image is started, the insertion unit 840 moves the sound player that is playing the selected sound source to a PIP window and then inserts the playing sound source as the background sound source of the image being captured.

If multiple sound sources are selected by a user, the insertion unit 840 may sequentially insert the multiple sound sources at regular intervals as the background sound source of the image being captured. Also, when the capture of an image is interrupted in the music mode, the playback of the selected sound source is paused, that is, the insertion of the selected sound source is stopped, and when the capture of the image is resumed, the selected sound source is played again, whereby the selected sound source may be inserted as the background sound source of the image being captured.

Of course, if at least one of a playback section, a playback start point and a playback end point is set in the selected sound source by the selection unit 820, the insertion unit 840 may insert the selected sound source as the background sound source of the image being captured based on information related to the playback.

The generation unit 850 generates an image in which at least one sound source selected by a user is inserted as the background sound source.

Here, when the capture of an image is terminated based on the user input in the music mode, the generation unit 850 may generate an image in which a sound source is inserted, or may generated an image in which a sound source is inserted after arranging a preset watermark in the predefined area of the captured image.

The storage unit 860 stores all the data for implementing the present invention, for example, algorithms, applications, data related to various effects, sound sources, videos in which sound sources are inserted, videos recorded in the general mode, and the like.

Here, when the image in which the selected sound source is inserted as the background sound source is displayed, the storage unit 860 may store the image in which a sound source is inserted in the state in which the video in a PIP window, such as a music video or the like, is also included in the image, or in the state in which the video in the PIP window is excluded from the image, based on the user selection.

Of course, it will be clear to those who skilled in the art that the apparatus according to the present invention may perform all the functions of the above-described method.

The aforementioned system or apparatus may be embodied as a hardware element, a software element, and/or a combination of a hardware element and a software element. For example, the system, apparatus and elements described in embodiments may be embodied using at least one general-purpose computer or special-purpose computer such as a processor, a controller, an arithmetic logic unit (ALU), a digital signal processor, a microcomputer, a field programmable array (FPA), a programmable logic unit (PLU), a microprocessor, or another apparatus for executing and responding to an instruction. The processor may execute an operating system (OS) and at least one software application that runs on the OS. Also, the processor may access, store, operate, process, and create data in response to the execution of software. For the convenience of understanding, a single processor may be used, however, those skilled in the art may appreciate that the processor may include a plurality of processing elements and/or a plurality of processing element types. For example, the processor may include a plurality of processors or a single processor and a single controller. Further, another processing configuration such as a parallel processor is possible.

The software may include at least one of a computer program, a code and an instruction solely or in combination, configure the processor to operate as desired, or instruct the processor to operate independently or collectively. The software and/or the data may be embodied permanently or temporarily in any type of machine, component, physical equipment, virtual equipment, computer storage medium or device, or transmitted signal wave, in order to be interpreted by the processor or to provide the processor with the instructions or the data. The software may be distributed on computer systems connected over a network, and may be stored or implemented in the distributed method. The software and the data may be stored in one or more computer-readable storage media.

The methods according to the above embodiments may be implemented as program instructions that can be executed by various computer means and may be recorded on a computer-readable storage medium. The computer-readable storage medium may include program instructions, data files, and data structures, either solely or in combination. Program instructions recorded on the storage medium may have been specially designed and configured for the embodiments of the present invention, or may be known to or available to those who have ordinary knowledge in the field of computer software. Examples of the computer-readable storage medium include all types of hardware devices specially configured to record and execute program instructions, such as magnetic media such as a hard disk, a floppy disk, and magnetic tape, optical media such as compact disk (CD)-read only memory (ROM) and a digital versatile disk (DVD), magneto-optical media such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

According to the embodiments of the present invention, when an image is captured, local sound sources stored in a user device, such as a smart phone or the like, and external sound sources, such as background music (BGM), sound effects, dialogue, songs or music videos provided from an external sound source provision service, are automatically inserted as a background sound source of the image that is being captured, whereby an image in which a sound source is inserted may be generated.

Although the present invention has been shown and described with reference to limited embodiments and the accompanying drawings, it will be appreciated by those skilled in the art that various changes and modifications may be made from the above descriptions. For example, even if the aforementioned technologies are carried out in an order differing from the one described above and/or illustrated elements, such as systems, structures, devices and circuits, are combined or united in forms differing from those described above or are replaced or substituted with other elements or equivalents, the same results may be achieved.

Accordingly, it should be noted that other implementations, other embodiments, and equivalents of the accompanying claims also fall within the scope of the accompanying claims.

What is claimed is:

1. A method for generating an image in which a sound source is inserted, comprising:
displaying a subject, an image of which is captured using a camera;
selecting a sound source;
when an image including the subject is captured, inserting the selected sound source in the image as a background sound source of the image being captured; and
generating an image in which the selected sound source is inserted as the background sound source.

2. The method of claim 1, wherein:
selecting the sound source is configured to display a sound player on a screen and to select the sound source in the sound player based on user input, and
inserting the selected sound source is configured such that, when an image capture function is selected based on the user input, the sound player that is playing the selected sound source is moved to a Picture-In-Picture (PIP) window and then the image is captured.

3. The method of claim 1, further comprising:
when a sound player is displayed on a screen, displaying a preset advertisement on a part of the screen.

4. The method of claim 1, further comprising:
setting a playback start point of the selected sound source based on user input,
wherein inserting the selected sound source is configured such that a part of the selected sound source, starting from the set playback start point, is inserted as the background sound source of the image being captured.

5. The method of claim 1, further comprising:
setting a playback section of the selected sound source based on user input,
wherein inserting the selected sound source is configured such that the set playback section of the selected sound source is inserted as the background sound source of the image being captured.

6. The method of claim 1, wherein inserting the selected sound source is configured such that, when capture of the image is interrupted, playback of the selected sound source is paused, and when the capture of the image is resumed, the selected sound source is played again, whereby the selected sound source is inserted as the background sound source of the image being captured.

7. The method of claim 1, wherein:
selecting the sound source is configured to select multiple sound sources based on user input, and
inserting the selected sound source is configured to sequentially insert the multiple sound sources at regular intervals as the background sound source of the image being captured.

8. The method of claim 1, wherein inserting the selected sound source is configured such that, when capture of the image is interrupted, playback of the selected sound source is paused, and when the capture of the image is resumed after another sound source is newly selected by user input, the newly selected sound source is played, whereby the first selected sound source and the newly selected sound source are sequentially inserted as the background sound source of the image being captured.

9. A method for generating an image in which a sound source is inserted, comprising:
displaying any one image selected from among multiple images that have been stored in advance;
selecting a sound source;
inserting the selected sound source as a background sound source of the selected image; and
generating an image in which the selected sound source is inserted as the background sound source for the selected image.

10. An apparatus for generating an image in which a sound source is inserted, comprising:
a display unit for displaying a subject, an image of which is captured using a camera;
a selection unit for selecting a sound source;
a capture unit for capturing an image including the subject;
an insertion unit for inserting the selected sound source as a background sound source of a captured image when the image including the subject is captured; and
a generation unit for generating an image in which the selected sound source is inserted as the background sound source.

11. The apparatus of claim 10, wherein:
the selection unit selects the sound source based on user input in a sound player displayed on a screen, and
when an image capture function is selected based on the user input, the capture unit captures the image after moving the sound player that is playing the selected sound source to a Picture-in-Picture (PIP) window.

12. The apparatus of claim 10, wherein the display unit displays a preset advertisement on a part of a screen when a sound player is displayed on the screen.

13. The apparatus of claim 10, wherein:
the selection unit sets a playback start point of the selected sound source based on user input, and
the insertion unit inserts a part of the selected sound source, starting from the set playback start point, as the background sound source of the captured image.

14. The apparatus of claim 10, wherein:
the selection unit sets a playback section of the selected sound source based on user input, and
the insertion unit inserts the set playback section of the selected sound source as the background sound source of the captured image.

15. The apparatus of claim 10, wherein the insertion unit inserts the selected sound source as the background sound source of the captured image in such a way that when capture of the image is interrupted, playback of the selected sound source is paused, and when the capture of the image is resumed, the selected sound source is played again.

16. The apparatus of claim 10, wherein:
the selection unit selects multiple sound sources based on user input, and
the insertion unit sequentially inserts the multiple sound sources at regular intervals as the background sound source of the captured image.

17. The apparatus of claim 10, wherein when capture of the image is interrupted, playback of the selected sound source is paused, and when the capture of the image is resumed after another sound source is newly selected by user input, the newly selected sound source is played, whereby the insertion unit sequentially inserts the first selected sound source and the newly selected sound source as the background sound source of the captured image.

18. The apparatus of claim 10, wherein the image in which the selected sound source is inserted as the background sound source is capable of being shared through at least one preset application.

19. The apparatus of claim 11, wherein the selection unit provides sound sources collected by crawling one or more preset external sound source provision services or sound source files downloaded based on a sound source list previously provided by a service, and selects the sound source from among the provided sound sources based on the user input.

20. The apparatus of claim 11, further comprising:
a storage unit for storing the image in which the selected sound source is inserted as the background sound source in a state in which the PIP window is included in the image or in a state in which the PIP window is excluded from the image depending on a selection by a user, when the image in which the selected sound source is inserted as the background sound source is displayed.
